(19) United States
(12) Patent Application Publication
(10) Pub. No.: US 2012/0056439 A1
(43) Pub. Date: Mar. 8, 2012

(54) ADAPTER DEVICE

(76) Inventor: Fredrik Stendal, Vasteras (SE)

(21) Appl. No.: 13/319,189

(22) PCT Filed: May 6, 2010
(86) PCT No.: PCT/SE2010/050500

§ 371 Date: Nov. 7, 2011

(30) Foreign Application Priority Data
May 7, 2009 (SE) 0900623-0

(51) Int. Cl. E05B 15/02; B23P 11/00; E05B 17/00

(52) U.S. Cl. 292/340; 292/346; 29/428

(57) ABSTRACT

The invention relates to an adapter device (3, 45) for use with an open strike plate (5) designed to cooperate with a lock comprising a bolt or latch in order to lock a lockable element in a fixed position. The invention also relates to a strike plate arrangement (1) comprising an open strike plate (5) in combination with an adapter device (3). The invention also relates to a method of attaching an adapter device (3) and a strike plate (5) in or on a jamb or lockable element.

### TECHNICAL FIELD

The present invention relates to an adapter device for use with an open strike plate arranged in cooperation with a lock, and a strike plate arrangement comprising an open strike plate and an adapter device.

### PRIOR ART

Mechanical locks for locking lockable elements, such as doors, trap doors or windows, usually comprise a bolt or a latch which is extendable into a hollow or opening arranged in a strike plate. The strike plate blocks the bolt or latch from moving sideways, so that the lockable element becomes locked. Some versions of electric locks, however, may comprise electric strike plates for the purpose of allowing electrical opening of a lockable element. The electric strike plate comprises an open strike plate, designed to allow sideway movement of the bolt or latch out of the open strike plate, even though the bolt is extended, and an electric lock member, comprising an electrically controlled, movable member that moves between a blocking state, in which the bolt or latch is blocked from moving out of the open strike plate, and a non-blocking state allowing opening.

One problem with electric locks is that the electric lock member is sensitive, so that the lock may cease to function in harsh or dirty environments. Also, due to safety reasons, most electric locks are designed to allow opening of the lockable element in case the electricity is cut. These features are particularly adverse during construction or repair of a building when conditions are dirty and there is no, or only a limited supply of, electricity, leading to that mechanical locks are usually relied upon until the very end of the construction phase, after which the mechanical locks are replaced with electrical locks.

### SUMMARY OF THE INVENTION

One object of the present invention is to alleviate the problems and costs involved with the prior art.

According to a first aspect of the invention this object is achieved with an adapter device according to claim 1. According to a second aspect of the invention this object is also achieved with a strike plate arrangement according to claim 10.

By providing an adapter device comprising a rigid blocking element arranged to block sideway movement of the bolt or latch out of the bolt opening in the second direction when the adapter device is combined with the open strike plate, it is no longer necessary to first use a closed strike plate during construction of a building, and then to later replace the closed strike plate with an open strike plate when providing the electric lock. Instead an open strike plate in combination with an adapter device may be installed directly. Hence the costs involved are decreased. Furthermore, since the blocking element is rigid, it is not affected by either lack of electricity at a building site, nor of dirt and such like.

The blocking element is preferably rigid and immovable relative to the adapter device. Preferably the adapter device is also adapted to be rigidly attached to the open strike plate. The adapter device is preferably also removable from the open strike plate. In one embodiment the fixed blocking element comprises a blocking plate edge for blocking the bolt from opening in the second direction. In another embodiment the adapter device may be designed with a shape similar to the shape of the electric lock member, wherein the adapter device may be provided in the same location as the location in which the electric lock member may later be provided.

The open strike plate is preferably designed to cooperate with a lock comprising a bolt or latch in order to lock a lockable element in a fixed position, the open strike plate comprising a bolt opening designed to allow extension and retraction of the bolt from the lock into the bolt opening in a first direction, and to allow movement of the bolt out of the bolt opening in a second direction, even in case the bolt is in an extended state.

A strike plate may comprise a plate attached onto or into a door jamb or similar. The bolt opening may then open into a hollow provided either in the strike plate or in the door jamb for receiving the bolt or latch. The lock with the bolt may similarly be provided inside or on the outside of the lockable element. The lock may in itself be either mechanical, electrical or both. Naturally, the strike plate may instead be provided in the lockable element while the lock is provided in a jamb, wall or other rigid construction. A lockable element may be a door, trap-door, window, hatch, gate etc.

In one embodiment the adapter device comprises an adapter opening designed to at least partly coincide with the bolt opening for allowing extension and retraction of the bolt from the lock into the bolt opening in the first direction. Preferably, the adapter opening is also designed to prevent the bolt from moving out of the bolt opening in the second direction. Hence the strike plate arrangement and the strike plate with the adapter device may be used as a mechanical lock, for example until an electric lock member is provided.

The strike plate arrangement and the adapter device may also be used as, or instead of, a normal, closed strike plate. Hence a strike plate manufacturer needs only to manufacture open strike plates for all product families, even for mechanical locks, since it is easy to transform an open strike plate into a closed strike plate by providing the adapter device. Thus the number of strike plate product types decreases, giving a better economy of scale. This is particularly advantageous when manufacturing small series.

According to a further embodiment the adapter device is attachable to and detachable from a jamb and/or lockable element. Hence the adapter device may both be installed and removed repeatedly. In particular, the adapter device may be removed if it is no longer needed. The adapter device may also be reused for another strike plate once it is no longer needed for its previous strike plate. Preferably, the adapter device is also attachable to and detachable from the open strike plate. Hence it is simple to install both the adapter device and the strike plate simultaneously or separately.

According to one embodiment the adapter device comprises at least one attachment and/or detachment member to allow attachment and detachment of the adapter device to or from the open strike plate. Preferably, the at least one attachment and/or detachment member is arranged to cooperate with a similar or corresponding attachment/detachment member provided on the open strike plate for fastening the strike plate in its place. Preferably the attachment and/or detachment member is provided in a standard position, that is, in a position selected according to a set standard. Thus the adapter device may be used without adaptation with all strike plate designs following the same standard.

According to one embodiment the adapter device is designed for replacing and/or to be replaced by, an electric lock member in an electric strike plate. This is advantageous for example when installing the adapter device into a strike plate arrangement intended to be used as an electric strike plate. This is also advantageous when replacing the adapter device with an electric lock member for later turning the strike plate arrangement into an electric strike plate.

According to one embodiment the adapter device comprises an adapter plate adapted to be attached in parallel with and/or directly onto or beneath the open strike plate. Hence the adapter device fits snugly, wherein it is easier to make room for the adapter device inside a door jamb or similar. The adapter plate may also strengthen the strike plate making the strike plate arrangement more difficult to break.

Preferably the size of the adapter plate is smaller than the size of the strike plate. Preferably the length of the adapter plate is smaller than 75% of the length of the strike plate. Thus it is easier to make room for and install the adapter device. Preferably the adapter plate is smaller than the smallest strike plate in the strike plate family for which it is designed. Hence the same adapter plate may be used for all strike plates within the same strike plate family.

According to one embodiment the adapter device comprises a supporting plate, which may be angled in relation to the adapter plate, for supporting the adapter plate. Hence the adapter plate becomes more stable and more durable, so that it is more difficult to break the lock.

According to one embodiment the supporting plate is L-shaped and is arranged to form a U-shape with the adapter plate. Hence the bottom portion of the support plate may be firmly supported by a floor portion in the hollow into which the strike plate arrangement is to be inserted in a door jamb or similar.

### BRIEF DESCRIPTION OF THE ATTACHED DRAWINGS

The invention is now to be described as a number of non-limiting examples of the invention with reference to the attached drawings.

FIG. 1 shows an adapter device according to one example of the invention.

FIG. 2 shows an exploded view of a strike plate arrangement comprising an adapter device and an open strike plate with one edge side cut off to increase visibility according to one example of the invention.

FIG. 3 shows the strike plate arrangement in FIG. 2 with the adapter device attached beneath the open strike plate, with one edge side of the strike plate cut off.

FIG. 4 shows the strike plate arrangement in FIGS. 2 and 3 with the edge side retained.

FIG. 5 shows an alternative example of an adapter device designed to emulate the shape of an electric locking member.

FIG. 6 shows one example of a method according to the invention.

### DETAILED DESCRIPTION

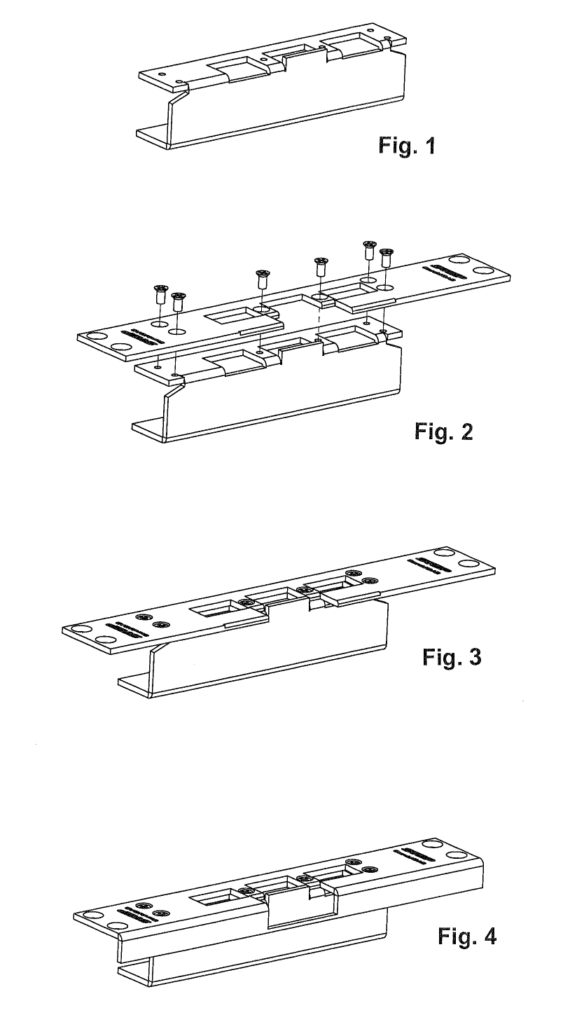

In FIGS. 1-4 a strike plate arrangement 1 comprising an adapter device 3 and an open strike plate 5, according to one example of the invention is shown. The open strike plate 5 is designed to cooperate with a lock (not shown) comprising a bolt or latch (not shown) in order to lock a lockable element (not shown) in a fixed position.

The open strike plate 5 comprises a bolt opening 7 designed to allow both extension and retraction of a bolt or latch from a lock and into the bolt opening 7 in a first direction 9. The bolt or latch may then be received inside a hollow arranged either within the strike plate 5 itself, or within a corresponding hollow in a jamb or lockable element, respectively. Since the strike plate 5 is an open strike plate, the bolt opening 7 is further designed to allow movement of the bolt or latch out of the bolt opening 7, and also out of the hollow, in a second direction 11, while the bolt or latch remain extended. Hence the open strike plate normally fails to lock the lockable element on its own.

The adapter device 3 is adapted to be arranged in combination with the open strike plate 5, as is exemplified in FIGS. 2-4. The adapter device 3 comprises a fixed blocking element 13 arranged to block movement of the bolt or latch out of the bolt opening 7 in the second direction 11 when the bolt or latch is extended. Hence the strike plate arrangement 1 comprising the adapter device 3 in combination with the open strike plate 5 together forms a fully functional, closed, strike plate for locking the lockable element.

The blocking element 13 is in this example rigid with respect of the adapter device 3. In this example the blocking element 13 is an integral part of the adapter device 3, and is hence also immovable in relation to the adapter device 3. In this example the blocking element 13 comprises a blocking plate edge 31 forming part of the circumference of the bolt opening 7, which part blocks an extended bolt or latch from moving in the second direction 11. The blocking plate edge 31 is in this example adapted to extend outwards from the bolt opening 7.

The adapter device 3 is attachable to and detachable from the open strike plate. In this example the adapter device is further attachable to and detachable from either or both of a door jamb or the lockable element. The adapter device 3 comprises attachment and/or detachment members 17 to allow attachment and detachment of the adapter device to or from the open strike plate and/or jamb or lockable element. In this example the attachment/detachment members 17 comprises holes for receiving a fastening element 21, such as a screw, nail, rivet, bolt or the like. The attachment and/or detachment members 17 are also arranged to cooperate with similar attachment/detachment members 19 provided on the open strike plate 5 for attaching the open strike plate 5 onto or inside a jamb or lockable element. In this example the attachment/detachment members 19 also comprises holes, wherein both the strike plate 5 and the adapter device 3 may be attached and/or detached at the same time using the same fastening elements 21.

In this example the attachment/detachment members 17, 19 are positioned at the same, standard position in relation to the bolt opening 7 or hollow for receiving the bolt or latch. In particular the attachment/detachment members 17 provided on the adapter device are positioned close to the bolt opening 7 in a standard location, wherein the same adapter device 3 may be used for any design or size of the open strike plate 5.

In this example the adapter device 3 comprises an adapter plate 23 adapted to be attached in parallel with the open strike plate 5. In this example the adapter plate 23 is also adapted to be positioned directly beneath the open strike plate 5, but in another example the adapter plate can alternatively be attached on top of the open strike plate 5. Such an adapter plate 23 may easily fit beneath or on top of a strike plate so that the installation of the adapter device 3 is simplified.

The adapter plate 23 is adapted in size so that the area of the adapter plate is smaller than the area of an open strike plate 5. In this example the area of the adapter plate 23 is smaller than the area of the smallest strike plate 5 of a product family to which the adapter plate is intended. Hence the same type of adapter plate 23 may be used in combination with anyone of the strike plates 5 in the family, regardless of the different sizes of the strike plates, since the adapter plate will not extend beyond the area of the smallest strike plate 5.

In this example the size of the strike plate is smaller than 35 cm in length, preferably smaller than 25 cm, and most preferably smaller than 20 cm. Furthermore, the strike plate is longer than 8 cm in length. The strike plate is also smaller than 7 cm in width, preferably smaller than 5 cm, and most preferably smaller than 4.5 cm in width. Preferably the strike plate is also wider than 2.5 cm.

The adapter device 3 further comprises a supporting plate 25 arranged to support the adapter device 3, in this example the adapter plate 23, in order to increase the durability of the adapter device 3. In this example the supporting plate 25 comprises a side plate 27 which extends at a right angle from the adapter plate 23. The side plate 27 further includes the blocking element 13 as an integrated part of the side plate. Hence the side plate 27 lends its support to the blocking element 13, wherein it is more difficult to break the lock.

In this example the supporting plate 25 further comprises a bottom plate 29, angled in relation to the side plate 27, for forming an L-shaped supporting plate 25. The bottom plate 29 is adapted to rest on the floor of a hollow or similar, in which the adapter device 3 and the open strike plate 5 are arranged, for example inside a jamb or a lockable element. The supporting plate 25 is integrated with the adapter plate 23, and hence the adapter device is U-shaped. In this example the U-shape is designed to correspond to the shape of a housing of an electrical lock member arrangement, wherein it is simple to replace the electrical lock member arrangement with the adapter device 3.

The adapter device 3 further comprises an adapter opening 15 designed to at least partly coincide with the bolt opening 7 for allowing extension and retraction of the bolt or latch from the lock into the bolt opening 7 in the first direction. Hence the adapter device 3 will not hinder the normal function of the bolt or latch. The adapter opening 15 is further designed to prevent the bolt or latch from moving out of the bolt opening in the second direction 11. The adapter opening is rigidly arranged in combination with bolt opening 7, wherein the adapter device 3 in combination with the open strike plate 5, form a closed strike plate arrangement 1. Hence the lock may function even though an electrically controlled member has not yet been provided.

The adapter device 3 further comprises two latch openings 33 formed on either side of the adapter opening 15, for allowing insertion and retraction of a latch inside the latch openings. Hence the adapter device 3 may be used in conjunction with a door provided with a latch as well as a bolt. Such a latch may for example be connected with a door handle or the like, wherein pulling the handle retracts the latch and letting go of the handle extends the latch by operation of a spring. By providing one latch opening on either side of the bolt opening 7 the adapter device 3 may be oriented in either direction regardless of on which side of the bolt the latch is provided.

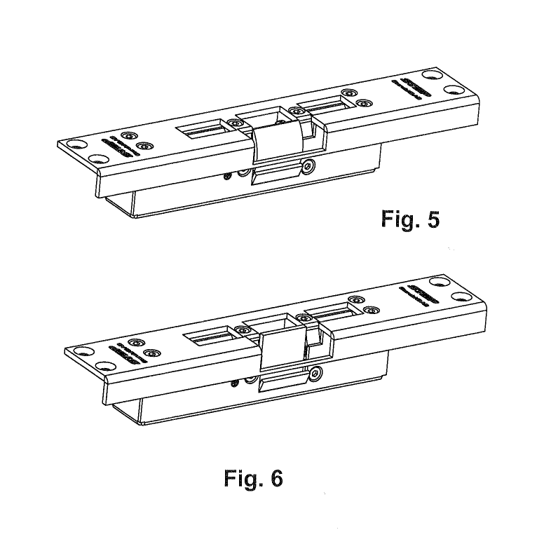

In FIG. 5 an electric lock member 40 and an adapter device 45 according to another example of the invention are shown.

The electric lock member 40 is adapted to be arranged in combination with an open strike plate, for example of the type shown in FIGS. 2-4, in order to form an electric strike plate. The electric lock member 40 comprises an electrically controlled, movable blocking member 43, which is movable from a first, blocking state, in which the blocking member blocks an extended bolt from moving out of a bolt opening in the strike plate, and a second, non-blocking state, in which the blocking member allows the extended bolt to move out of the bolt opening in the second direction.

The adapter device 45 is adapted to replace the electric lock member 40 in the electric strike plate. By replacing the electric lock member 40 with the adapter device 45 the electric strike plate is transformed into a closed strike plate arrangement. Naturally, the adapter device 45 may be correspondingly replaced by the electric lock member 40. Hence, depending on the present situation and environment, either an adapter device 45 or an electric lock member 40 may be installed in combination with the open strike plate.

In this example the adapter device 45 is further designed with a shape similar to the shape of the electric lock member 40. In this example the adapter device also comprises a blocking element 47 for blocking movement of the bolt, and having a shape similar to the shape of the movable blocking member 43 in its first, blocking state. Hence the replacement of the adapter device and the electric lock member with each other is simplified, since it is obvious for a worker where to install the replacing part. Also, it is guaranteed that there is room for the adapter device 45, since its shape corresponds to the shape of the electric lock member, for which the open strike plate is designed.

In FIG. 6 a method according to one example of the invention is shown. The method comprises a first step 60, in which an adapter device, for example according to the device in FIG. 1 or FIG. 5, is provided inside a hollow made in a door jamb. In a second step 62, an open strike plate, for example a strike plate in accordance with FIG. 2, is provided on top of the adapter device, wherein the adapter device is positioned beneath the open strike plate. In a third step 64, the adapter device and the open strike plate are both attached in the door jamb by fastening the adapter device and the strike plate with fastening members, in this case with screws. The adapter device and the open strike plate hence together form a closed strike plate arrangement, which may be used in combination with a mechanical lock provided in a door, for locking the door in a mechanical manner. Hence the strike plate arrangement is insensitive to dirt or other harsh conditions, and is not affected by a possible lack of electricity.

Subsequently, after for example completion of a new building or the completion of repair of a building, the invention comprises a fourth step 66, in which the adapter device is detached from the door jamb and is replaced with an electrical lock member as originally intended. The electrical lock member may comprise an electrically movable blocking member for blocking or allowing movement of a bolt or latch in a second direction, wherein the locking of a door or similar may be controlled remotely.

Hence, by delaying the installation of the electrical lock member and providing a simple and low-cost adapter device instead, it is neither necessary to subject an electrical lock member for extensive wear, nor to first install an expensive, closed strike plate and then to replace it with the intended open strike plate.

The invention is not limited to the examples shown but may be varied freely within the framework of the following claims. In particular, a device or arrangement according to the invention may comprise any combination of the features as shown in the examples above.

1. An adapter device (3, 45) for use with an open strike plate (5), the open strike plate being designed to cooperate with a lock comprising a bolt or latch in order to lock a lockable element in a fixed position, the open strike plate comprising a bolt opening (7) designed to allow extension and retraction of the bolt or latch from the lock into the bolt opening in a first direction (9), and to allow movement of the bolt or latch out of the bolt opening in a second direction (11) while the bolt or latch is extended, characterized in that the adapter device (3) comprises a rigid blocking element (13) arranged to block movement of the bolt or latch out of the bolt opening in the second direction when the adapter device is combined with the open strike plate.

2. An adapter device according to claim 1, characterized in that the adapter device comprises an adapter opening (15) designed to at least partly coincide with the bolt opening (7) for allowing extension and retraction of the bolt or latch from the lock into the bolt opening in the first direction.

3. An adapter device according to claim 2, characterized in that the adapter opening (15) is designed to prevent the bolt or latch from moving out of the bolt opening in the second direction.

4. An adapter device according to any of the claims 1-3, characterized in that
the adapter device (3) is attachable to and detachable from the open strike plate.

5. An adapter device according to any of the claims 1-4, characterized in that
the adapter device comprises attachment and/or detachment members (17) to allow attachment and detachment of the adapter device to or from the open strike plate, which attachment and/or detachment members are arranged to cooperate with similar attachment/detachment members (19) provided on the open strike plate for fastening the strike plate in place.

6. An adapter device according to any of the claims 1-5, characterized in that the adapter device is designed for replacing an electric lock member (40) in an electric strike plate.

7. An adapter device according to any of the claims 1-6, characterized in that the adapter device comprises an adapter plate (23) adapted to be attached in parallel with and directly onto or beneath the open strike plate.

8. An adapter device according to claim 7, characterized in that the adapter device comprises a supporting plate (25), which is angled in relation to the adapter plate for supporting the adapter plate.

9. An adapter device according to claim 8, characterized in that the supporting plate (25) is L-shaped and is arranged to form a U-shape with the adapter plate (23).

10. A strike plate arrangement comprising an open strike plate (5) being designed to cooperate with a lock comprising a bolt or latch in order to lock a lockable element in a fixed position, the open strike plate comprising a bolt opening (7) designed to allow extension and retraction of the bolt or latch from the lock into the bolt opening in a first direction (9), and to allow movement of a bolt or latch out of the bolt opening in a second direction (11) while the bolt or latch is extended, characterized in that the strike plate arrangement (1) comprises an adapter device (3) comprising a rigid blocking element (13) arranged to block movement of the bolt or latch out of the bolt opening in the second direction when the adapter device is combined with the open strike plate.

11. A method of providing a lock for a lockable element comprising the step:
attaching an adapter device according to claim 1 in combination with a strike plate (5) in or on a jamb or a lockable element.
